(19) United States
(12) Patent Application Publication
(10) Pub. No.: US 2013/0264267 A1
(43) Pub. Date: Oct. 10, 2013

(54) Aquarium Algae and Detritus Removal Electromechanical Apparatus

(71) Applicant: Yuen-Kong Ho, Temple City, CA (US)

(72) Inventor: Yuen-Kong Ho, Temple City, CA (US)

(21) Appl. No.: 13/442,792

(22) Filed: Apr. 9, 2012

(51) Int. Cl. A01K 63/04; B01D 35/02

(52) U.S. Cl. 210/239; 210/251; 210/541; 210/242.1

(57) ABSTRACT

The invention is a water submersible device that dislodges filament algae or detritus from infected objects such as rocks and disposes the matters into a removable compartment for removal from the aquarium or pond.

It has a water pump (1) that not only sucks in water from its water inlet (2) opening but also has a drill bit (3) extending out from the center of the same inlet opening. When it makes contact with the filament algae or detritus on objects, it breaks and swirls them up quickly and disposes them to the water outlet side of the pump. There, contains a collection cup (5) with filter materials (4) for easy matters disposal. The pump is secured onto a rod (7) by a hinge joint (6) for easy angle adjustment by the user holding the handle (8) above water. It is powered by a battery (9) inside the handle.

### BACKGROUND

This invention addresses one of the more annoying aquarium and pond maintaining issue plaguing fish, coral and plant keeping hobbyists worldwide. That is; combating uncontrolled growth of algae in their aquariums and ponds.

Being in the freshwater fish, saltwater fish and corals keeping hobbies for years, I have had more than my fair share of algae issues in my tanks. There are basically two types of algae; filament type and film/sheet type. Filament algae include hair algae, beard algae, brush algae, fuzz algae and staghorn algae etc. Film/sheet type algae include brown algae (diatom), green algae and Blue-green algae etc.

Every aquatic life sustaining aquarium consists of alga of one kind or the other. Its existence signals a favorable environment that consists of water, adequate lighting and organic as well as inorganic nutrients. Incidentally, it is similar to the one necessary for sustaining the healthy lives for plant, fish and coral that hobbyists very much intend to keep. Therefore, it is close to impossible to eliminate algae completely from a healthy aquarium.

Many fish and invertebrates consume algae for food, which help to control the amount of them to a certain degree. Before this invention, to combat filament algae, hobbyists like me have to resort to manually remove them by hands. Scrubbing them with a toothbrush and/or picking them off the decors, rocks, coral and plants either in place that risks spreading the algae and debris all over the tank or taking the infected objects out of the aquarium first which quite often is either hard or not practical at all! The cleaning endeavor is often quite daunting, time consuming, inefficient and disruptive to the creatures in the tank as well as beneficial bacteria resided in the objects such as rocks if they have to be taken out from the water for cleaning. Some desperate hobbyists even have to resort to chemicals to combat with them when previous methods are not close to enough. More often than not, this radical decision affects or kills their favorable animals and plants in the process!

As long as algae are under control and do not cover or overtake the plants, corals, rocks, décors or ornaments in their tanks, most hobbyists are happy to do weekly chore of cleaning or trimming the algae and perform partial water change to achieve esthetically clean looking tanks!

This invention is a handheld, water submersible and self sufficient apparatus that makes the chore of manually removing algae, especially filament algae and detritus from hobbyists' aquariums significantly easier, faster and thorough right at the infected spots under water without disrupting other inhabitants in the aquariums. The dislodged algae and/or detritus are collected and easily removed from the aquarium and pond.

### SUMMARY OF INVENTION

A submersible electromechanical rotating device such as a submersible water pump that has a drill bit installed at its water suction opening that cuts, dislodges and swirls up the algae and detritus from objects under water such as rocks and plants to be sucked up by the suction force created by the impeller of the pump through the length adjustable water inlet extension tube opening.

Orientation or direction of the device [007] can be adjustable relative to the axis of the holding rod to fit the contour of algae or detritus locations.

Dislodged algae and detritus expelled from the device [007] are filtered and collected into a removable compartment for easy disposal.

An extensible rod to adapt to different depth of aquariums that holds the device [007] on one end and allows the user to keep his or her hands dry while maneuvering the light weighted device [007] from above the water on the other end.

Instead of using an extensible rod [010], the device [007] can also be remotely controlled and operated by supporting it onto a submarine like submersible mechanism with steering control and by developing and using embedded computer controlled hardware and software.

### BRIEF DESCRIPTION OF THE DRAWINGS

FIG. 1 shows one of the realizations of this invention in a handheld format.

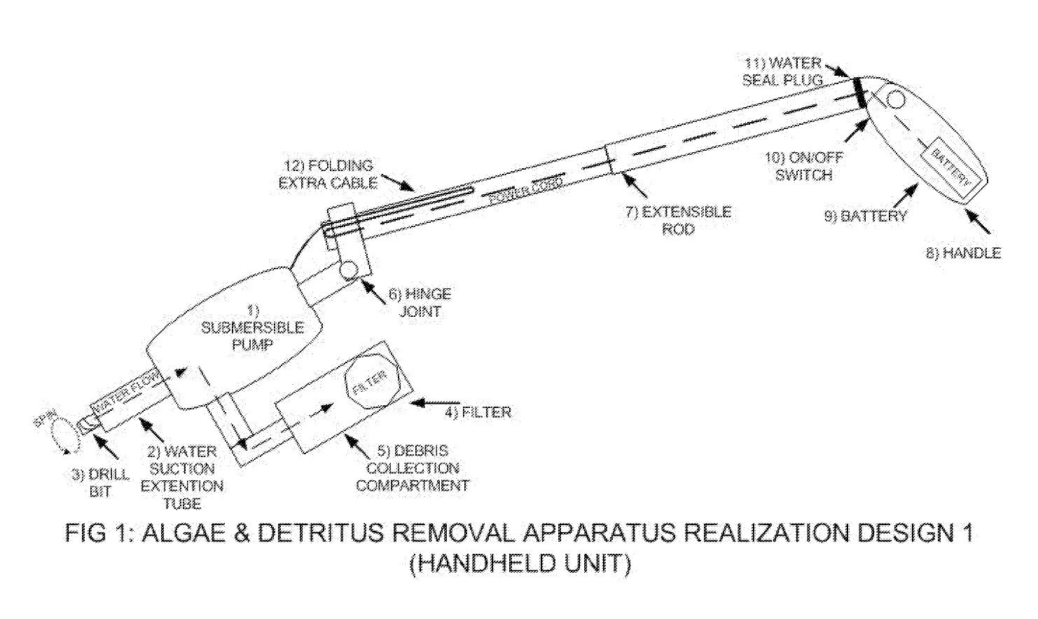

FIG. 2 shows another realization of this invention in a remotely controllable format.

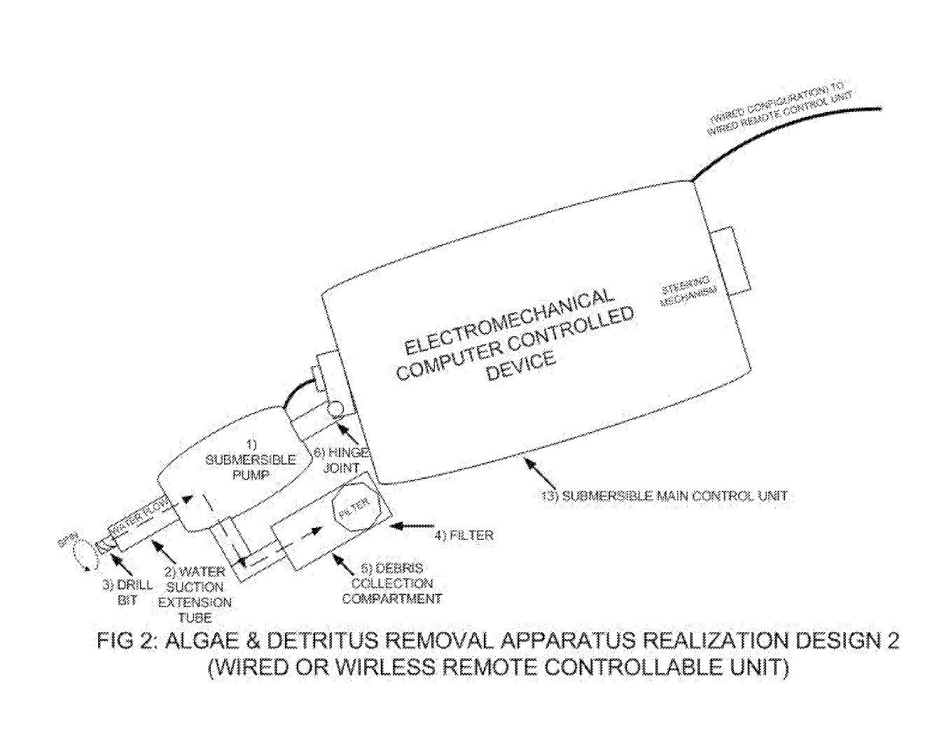

FIG. 3 shows the design of the impeller for this invention.

### DETAILED DESCRIPTION

One implementation of this invention is to use a specially designed battery operated direct current (DC) magnetic coupled water submersible pump (1) that not only can suck in water from its water inlet tube opening (2) but it also has a protruded hollow tube at the center of its impeller that can accept a bit (3) similar to a steel drill bit extending out from the center of the same water inlet tube opening.

When the submersible pump (1) is in operation, the drill bit (3) can rotate at the same rate as the impeller inside the pump and its angle relative to the axis of the holding rod can be adjusted. When it comes into contact with the algae or detritus, it twists, breaks and swirls up the filament algae and matters quickly. The matters are being sucked up immediately by the length adjustable water inlet extension tube (2) by the force of the rotating impeller and disposed out to the water outlet side of the pump. There, the invention consists of a removable debris collection cup (5) that contains cotton and/or nylon foam types of filter materials (4) to collect and filter the algae and matters to prevent them from going back and contaminating the hobbyist's aquarium or pond.

In some situations where 100% discharging of the dislodged matters from the aquarium or pond is desirable, a hose inserted into the water outlet tube of the pump (1) can be used to replace the debris collection cup (5) and achieve partial water change for the aquarium at the same time.

The length adjustable water inlet extension tube (2) allows the shortening of length of the exposed drill bit so as to handle the shorter form of algae like the brush algae better by increasing the suction force for removing the dislodged algae. By retracting the mating depth between the water inlet tube of the pump (1) to the extension tube (2), the exposed drill bit can varies from about 0.5 inch down to about 0.1 inch.

The invention also contains a segmented extensible rod (7) similar to a fishing rod that holds the submersible pump firmly onto one end and allows the hobbyist to adjust it to a proper length to fit the depth of his or her tanks. The other end of the rod is plugged with an air sealed plug (11) to enhance buoyancy of the submersible portion of the apparatus and prevent water from accidentally spilling into the handle (8). While holding the handle installed at that end of the rod, the user can precisely maneuver the light weighted device under water to the exact algae or detritus location without getting his or her hands wet and maintain good eye-hand coordination during the whole cleaning process. When using the invention at a reduced length to fit shorter aquariums better, the extra cable (12) length that conveys power from the battery (9) to the pump (1) can be folded, inserted and stored back inside the hollow rod at the pump side opening.

Furthermore, at the junction where the pump is connected to the rod, the invention has a mechanism similar to a door hinge (6) joint that allows the hobbyist to adjust the angle of the pump relative to the axis of the rod. This allows arbitrary orientation of the drill bit and the water inlet tube to best maneuver to and fit with the contour of the algae and detritus infected locations.

For applications where a more heavy duty submersible water pump with bigger drill bit is needed to combat with more severe algae problem, an AC powered water pump can be employed in place of the DC water pump.

For big aquariums where reaching the algae or detritus spots by the rod is not practical, the pump assembly can be supported by a waterproof submarine like housing with steering mechanism (13) where embedded computer controlled hardware and software can be employed to remotely control the pump.

Not All algae in the aquarium are necessarily ‘bad’—a certain amount is inevitable where there is water, light and nutrients. However, some types of algae are certainly a nuisance, if for no other reason than looking unsightly. Therefore, this invention will be beneficial to every aquarium keeper to allow he or she to easily control the algae growth and allow the living cleaning crews such as fish and snails resided in the aquarium a winning chance to clean up the remaining algae to achieve a close to algae free environment.

User can also spot clean sheet type algae on rocks or plants using this invention by installing another bit that has a elastic foam pad on it to wipe and suck them up into the filter compartment of the device.

Another usage of this invention is to trim the height of desirable plants and grass that aquarists are keeping such as Dwarf Hairgrass, Micro Sword, Japanese Rush, Peper Grass and leaves of Myrio-Green, Stargrass, Needle Leaf, Water Sprite, Filigree, Myrio and Java Moss etc. by using a propeller blade like bit.

The invention further can be used to pick up any free flowing or suspending matters in the water such as debris, fecal matters and algae just by directing the inlet tube to the objects. To allow more suction force at close distance and avoid disturbing delicate organisms in the tank, the drill bit can be removed if desired making this invention a likely tool to be used for regular spot cleaning by the general aquarium keeping hobbyists.

### CONCLUSION

Algae or plants cutting, trimming and detritus or matters removal and collection functions are all handled by this invention in a self contained and sufficient device. The operator can easily maneuver the device to any spot in the water and the angle of the water inlet tube and the drill bit can be adjusted to fit the contour of the area of interest. The extensible rod of the handheld implementation allows easy adjustment of its length to fit the depth of different aquariums and ponds. It also makes packaging and shipping of the product significantly easier.

A more flexible but much more complicated implementation of this invention can be made using computer controlled hardware and software to handle big aquariums where a remotely controllable device is more practical and desirable.

1) The invention is a handheld, water submersible and self-sufficient apparatus for removing matters such as filament algae or detritus on objects such as rocks under water in an aquarium or pond. It uses a submersible electromechanical rotating device such as a water submersible water pump with its water sucking inlet section possesses an installable and replaceable drill bit that extends out from the center of the same water inlet opening and its water disposal outlet section possesses an installable and removable debris collection and filter compartment. The above said pump assembly is supported onto one end of a rod by a hinge joint assembly. The user maneuvers the pump from above the water by holding the handle at the other end of the rod. The handle also serves as the battery storage compartment along with a power on/off switch. The invention allows the user to easily adjust the angle of the rotating drill bit relative to the axis of the rod and pinpoints it onto the matters on infected objects to dislodge, suck, filter and remove the matters from objects under water. The matters can be algae, moss, fish fecal matters and small or dust like particles etc. that are suspending in water or attached onto rocks, plants, corals, decors or ornaments in an aquarium or pond.

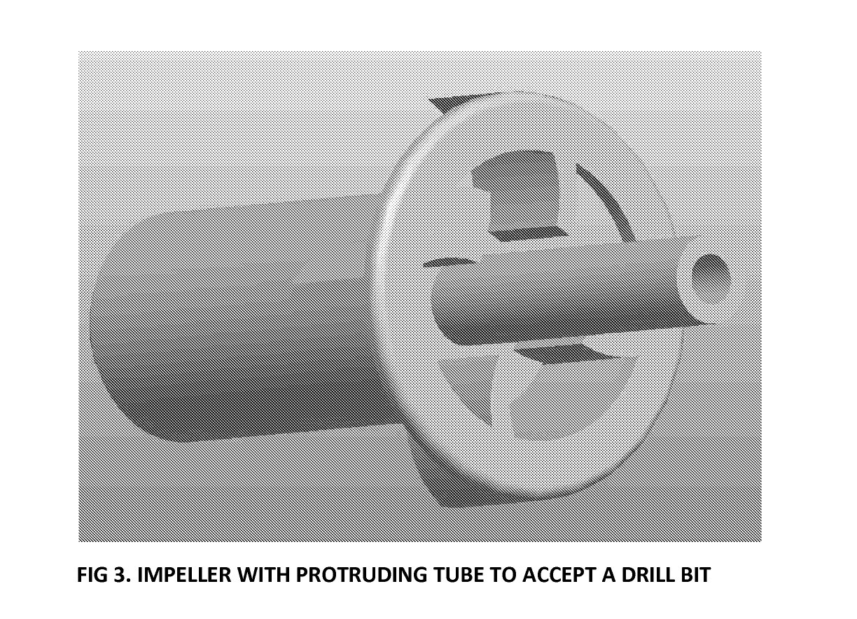

2) The submersible water pump (1) in the said apparatus in claim 1) has a specially designed impeller as shown in FIG. 3 which has a protruding hollow tube at the center to support the insertion of a drill bit (2) that extends out from the same water inlet tube opening.

3) A plastic tube (3) with inner diameter just bigger than the outer diameter of the water inlet tube of the said pump in claim 1) is used by the user to insert it over the water inlet tube opening all the way to the base plate of the pump and allows the water inlet opening to be extended to about 0.5 inch behind the length of the drill bit so as to enhance the suction force for the dislodged algae or matters. To further increase the suction force if necessary while removing very short hair or brush algae, the plastic tube can be retracted from the base plate of the pump by up to 0.4 inch so that the tip opening of the plastic tube can be adjusted down to just 0.1 inch shorter than the length of the drill bit. The above values are just a recommendation and not the limitation for the device. If a more powerful pump is used, the plastic tube can be shorter and still provides the necessary sucking force for the dislodged matters.

4) The bit, which extends out from the center of the plastic tube in claim 3), can be made like a drill bit, a bit with a cylindrical shaped head made from elastic foam materials or a bit with a propeller shaped head for cutting, wiping and trimming functions respectively. The bit plugs directly into the impeller in claim 2) with no need of a big long shaft going through a bulky chamber and complicated mating mechanisms that are required by the prior arts for cleaning just the side walls or gravels on the bottom of an aquarium. Therefore, based upon size, weight and maneuverability, all prior arts that use electromechanical means for cleaning gravels and walls for aquariums are not adequate for delicate spot algae or target detritus removal on objects that are above the gravel layer on rocks, plants, corals or suspending particles in water as performed efficiently by this invention.

5) The bit in claim 4) can also be removed from the pump (1) of the said apparatus in claim 1) if deemed desirable when sucking and removing loose matters other than filament algae that fall onto the surface of delicate organisms such as corals and plants or suspending matters in water in an aquarium or pond. This feature allows the invention also be useful as an apparatus for safe and simple spot cleaning for aquarium or pond maintenance.

6) A debris collection cup (5) connected to the water outlet opening of the said pump in claim 1) that contains filter materials (4) to prevent debris from entering back into the aquarium. The cup can be detached easily from the pump and its contents removed and cleaned.

7) If deemed desirable, the debris collection cup can be replaced by a hose mated to the water outlet of the pump in claim 1) to discharge the dislodged matters directly out of the aquarium or pond and achieve partial water change in the process.

8) A hinge joint assembly (6) that is secured onto the top of the said pump in claim 1) to allow the pump to swing and fixed at different angles relative to the axis of the rod to pinpoint the drill bit in claim 4) to match with the contour of the exact algae or detritus infected locations for effective cleaning.

9) A fixed length or extensible rod (7) that holds the hinge joint assembly in claim 8) onto one end and allows the user to maneuver and operate the pump in claim 1) from above the water level on the other end and be able to adapt to the depth of different aquariums or ponds.

10) The top opening of the rod in claim 9) is sealed with an air tight plug (11) to provide some buoyancy for the submersible portion of the apparatus to assist the user to easily and weightlessly maneuver the pump assembly in claim 1) under water to the algae or detritus infected spots.

11) A handle (8) that plugs onto the top end of the rod in claim 9) also houses a power on/off switch (10), a battery (9) or an external power source mating plug and a battery compartment for powering the said pump in claim 1).

12) When reduced length of the rod in claim 9) is used to fit shorter aquariums or ponds, the extra cable (12), that conveys power from the external power source or the battery in the handle (8) to the said pump in claim 1), can be folded, inserted and stored inside the hollow rod from the opening at the hinge joint assembly side.

13) One variant of the apparatus that can be realized differently is to put the pump in claim 1) and components in claim 2), 3), 4), 6) and 8) inside a waterproof submarine like housing (13) along with steering mechanisms and embedded computer controlled hardware and software. This device can then be controlled remotely by the user using a wired or wireless method to the target area where algae or matters can be removed easily for big aquariums like those in the public aquariums.
